(19) United States
(12) Patent Application Publication
(10) Pub. No.: US 2024/0411021 A1
(43) Pub. Date: Dec. 12, 2024

(54) WIRELESS SIGNAL PREDICTION

(71) Applicant: DISH Network Technologies India Private Limited, Bengaluru (IN)

(72) Inventor: Arun Pulasseri Kalam, Bangalore (IN)

(21) Appl. No.: 18/330,199

(22) Filed: Jun. 6, 2023

(51) Int. Cl. G01S 17/08; H04W 24/08

(52) U.S. Cl. CPC G01S 17/08; H04W 24/08

(57) ABSTRACT

The present disclosure provides methods and systems for monitoring an environment around a cell site. In one example, a method includes: selecting a location within a predetermined range around a cell site, the cell site having a transmitter configured to transmit a wireless signal to the selected location along a line of sight (LOS) therebetween; scanning, using a light detection and ranging (LIDAR) sensor in proximity to the cell site, an environment around the cell site to identify an obstacle between the cell site and the selected location; determining, based on the scanning, a degree of obstruction of the obstacle to a path of the LOS; and responsive to determining that the degree of obstruction exceeds a threshold level, altering an operational parameter of the cell site.

### BACKGROUND OF THE DISCLOSURE

Consumers have increasing demands on wireless network services (e.g., voice, data, multimedia services, etc.). Wireless network services can be provided by establishing wireless communications between a cell site and user equipment in the coverage area of the cell site. The signal quality or signal penetration performance of the wireless transmission is important because it directly affects the user experience. However, wireless signals (particularly 5G signals) transmitted from the cell site can be very sensitive to the neighborhood environment around the cell site. A potential obstacle or obstruction in the path of wireless signal transmission, if not timely identified, may cause serious problems to the signal quality.

### BRIEF SUMMARY OF THE DISCLOSURE

In accordance with some embodiments of the present disclosure, computer-implemented methods are provided. In one example, a method includes: selecting a location within a predetermined range around a cell site, the cell site having a transmitter configured to transmit a wireless signal to the selected location along a line of sight (LOS) therebetween, receiving, cell site environment data and identify an obstacle between the cell site and the selected location based on the cell cite environment data, the cell site environment data obtained by scanning an environment around the cell site using a LIDAR sensor in proximity to the cell site, determining, based on the scanning, a degree of obstruction of the obstacle to a path of the LOS, the degree of obstruction being characterized by a ratio of an obstruction distance of the obstacle to a total distance of the LOS and the obstruction distance being characterized by a dimension of the obstructing part along the path of the LOS, and responsive to determining that the degree of obstruction exceeds a threshold level, altering an operational parameter of the cell site.

In some embodiments, the method further comprises: selecting a first time point (T₁) and determining a first obstruction state of the obstacle at T₁, the first obstruction state including a first degree of obstruction of the obstacle at T₁, selecting a second time point (T₂) and determining a second obstruction state of the obstacle at T₂, the second obstruction state including a second degree of obstruction of the obstacle at T₂, and comparing the first obstruction state and the second obstruction state to determine a change of the obstacle.

In another example, a method includes: selecting a location within a predetermined range around a cell site, the cell site having a transmitter configured to transmit a wireless signal to the selected location along an LOS therebetween, receiving, cell site environment data and identify an obstacle between the cell site and the selected location based on the cell cite environment data, the cell site environment data obtained by scanning an environment around the cell site using a LIDAR sensor in proximity to the cell site, selecting a plurality of time points, determining, based on the scanning, a plurality of degrees of obstruction of the obstacle respectively corresponding to the plurality of time points, the degree of obstruction being characterized by a ratio of an obstruction distance of the obstacle to a total distance of the LOS and the obstruction distance being characterized by a dimension of the obstructing part along the path of the LOS, determining whether the degree of obstruction at one of the selected time points exceeds a threshold level, and responsive to determining that the degree of obstruction exceeds a threshold level, altering an operational parameter of the cell site.

In some embodiments, the method further includes measuring a set of wireless signals transmitted from the transmitter to a receiver placed in the selected location at each of the plurality of time points to generate a plurality of measurements data respectively corresponding to the plurality of time points, and calculating a plurality of signal quality scores of the wireless signals based on the plurality of measurements data, the plurality of signal quality scores respectively corresponding to the plurality of time points.

In accordance with some embodiments of the present disclosure, a cell site environment monitoring device is provided. In some embodiments, the cell site environment monitoring device includes: one or more processors; and a computer-readable storage media storing computer-executable instructions that, when executed by the one or more processors, causes the cell site environment monitoring device to: select a location within a predetermined range around a cell site, the cell site having a transmitter configured to transmit a wireless signal to the selected location along an LOS therebetween, receive cell site environment data and identify an obstacle between the cell site and the selected location based on the cell cite environment data, the cell site environment data obtained by scanning an environment around the cell site using a LIDAR sensor in proximity to the cell site, determine, based on the cell site environment data, a degree of obstruction of the obstacle to a path of the LOS, the degree of obstruction being characterized by a ratio of an obstruction distance of the obstacle to a total distance of the LOS and the obstruction distance being characterized by a dimension of the obstructing part along the path of the LOS, and responsive to determining that the degree of obstruction exceeds a threshold level, cause an alteration of one or more operational parameters of the cell site.

In accordance with some embodiments of the present disclosure, a system for monitoring wireless signal transmitted from a cell site is provided. In some embodiments, the system includes: a LIDAR sensor in proximity to the cell site; a wireless signal meter; a computer device including one or more processors; and a computer-readable storage media storing computer-executable instructions that, when executed by the one or more processors, causes the computer device to: select a location within a predetermined range around the cell site, the cell site configured to transmit a wireless signal to the selected location along a LOS therebetween; receive cell site environment data and identify an obstacle between the cell site and the selected location based on the cell cite environment data, the cell site environment data obtained by scanning an environment around the cell site using the LIDAR sensor; receive measurements data corresponding to an obstruction state of the obstacle, the first measurements data obtained by measuring a set of wireless signals received by a receiver placed in the selected location and transmitted from the transmitter; calculate a signal quality score of the wireless signals based on the measurements data; and determine whether the signal quality score falls within a predetermined range, the predetermined range indicating an acceptable performance of wireless transmission.

In some embodiments, when executed by one or more processors, the computer-executable instructions further cause the system to: obtain a distance between the obstacle and the cell site measured by the LIDAR sensor, calculate a distance between the obstacle and the transmitter, calculate the total distance of the LOS, and determine the obstruction distance of the obstacle.

In accordance with some embodiments, the present disclosure also provides a non-transitory machine-readable storage medium encoded with instructions, the instructions executable to cause one or more electronic processors of a system to perform operations of a method described herein.

### BRIEF DESCRIPTION OF THE DRAWINGS

A further understanding of various embodiments may be realized by reference to the following figures. In the appended figures, similar components or features may have the same reference label. Further, various components of the same type may be distinguished by following the reference label with a dash and a second label that distinguishes among the similar components. If only the first reference label is used in the specification, the description is applicable to any one of the similar components having the same first reference label irrespective of the second reference label.

FIG. 1 is a schematic diagram illustrating an example wireless communication system according to various embodiments.

FIG. 2 is a schematic diagram illustrating an example of a system according to various embodiments.

FIG. 3A and 3B are schematic diagrams illustrating an example process and stages thereof in accordance with various embodiments.

FIGS. 4A and 4B are a flow diagrams of exemplary methods according to various embodiments.

FIG. 5 is a flow diagram of another exemplary method according to various embodiments.

FIG. 6 is a flow diagram of yet another exemplary method according to various embodiments.

FIG. 7 is a schematic diagram illustrating an embodiment of a computer system according to various embodiments.

### DETAILED DESCRIPTION OF THE DISCLOSURE

The following Detailed Description is merely exemplary in nature and is not intended to limit the scope of the present disclosure or the application and uses of the teachings of the present disclosure.

In various embodiments, a method is provided to monitor wireless signal transmission performance. One insight provided by the present disclosure is that the method employs sensor techniques to proactively sense and monitor a neighborhood environment around a cell site (e.g., in a radial range from about 10 to about 2,000 feet from the cell site) for transmission of wireless signals (e.g., 5G signals) for the transmitter of the cell site. For example, one or more LIDAR sensors may be mounted on the cell site and/or in an environment around the cell site (e.g., landscape, plants, constructions, etc.) to accurately and precisely monitor the environment and track the environmental change around the cell site in a broad range. The LIDAR sensors can be used to identify a potential obstacle that likely obstructs the line of sight (LOS) transmission between the transmitter of the cell site and a particular location. The LIDAR sensors can be used to track the obstruction state of the obstacle, identify an on-going change of the obstruction state, and predict a future change of the obstruction state of the obstacle.

Another insight provided by the present disclosure is that the method can be used to measure the wireless signals and evaluate the impact of the identified obstacle on the wireless signal quality by processing a large amount of data obtained from LIDAR detection and wireless signal measurements. The wireless signal measurements data can be processed to calculate wireless signal quality scores that quantitatively represent the transmission performance of the cell site. The wireless signal quality can also be correlated to the obstruction state of the obstacle using data analysis techniques such as artificial intelligence or machine learning methods.

Yet another insight provided by the present disclosure is that the method can be used to train a machine learning model using the cell site environment data, obstruction state data, and the wireless signal measurement data. The machine learning model can be used to predict the in obstruction state of the obstacle as well as the wireless signal quality in a future time and recommend an action to take to remedy the signal quality loss by the obstacle.

Various embodiments described herein are directed to devices, systems, methods, and processes for providing a wireless communication system, particularly a 5G system. Herein, “5G” refers to communications systems, protocols, and technologies which use, for uplinks and/or downlinks, one or more of Single-Carrier Frequency Division Multiplexing (SC-FDM), Orthogonal Frequency-Division Multiplexing (OFDM) waveforms and the like, with non-limiting examples including Cyclic Prefix OFDM (CP-OFDM), Orthogonal Frequency Division Multi-Access (OFDMA), Weighted Overlap and Add OFDMA (WOLA/OFDMA), Single-Carrier Frequency Division Multiple Access (SC-FDMA), and Resource Spread Multiple Access (RSMA). Further, “5G” herein refers to various uses of frequency range allocations by governmental authorities, such as the United States Federal Communications Commission, (each allocation being a “5G band”). Other frequency allocations may be used in other jurisdictions. The 5G band allocations may include “High-Bands” such as frequencies above twenty-four Gigahertz (24 GHZ) (commonly also referred to as millimeter wave (“mmWave”) frequencies), “Mid-Bands” such as frequencies between one and six Gigahertz (1-6 GHZ), and “Low-Bands” such as those below one Gigahertz (1 GHz). It is appreciated that a 5G band used for a given implementation and/or at a given time will influence signal propagation, data rate, latency, power needs, and other signal characteristics. Other frequency allocations may be used in the U.S. and/or in other jurisdictions.

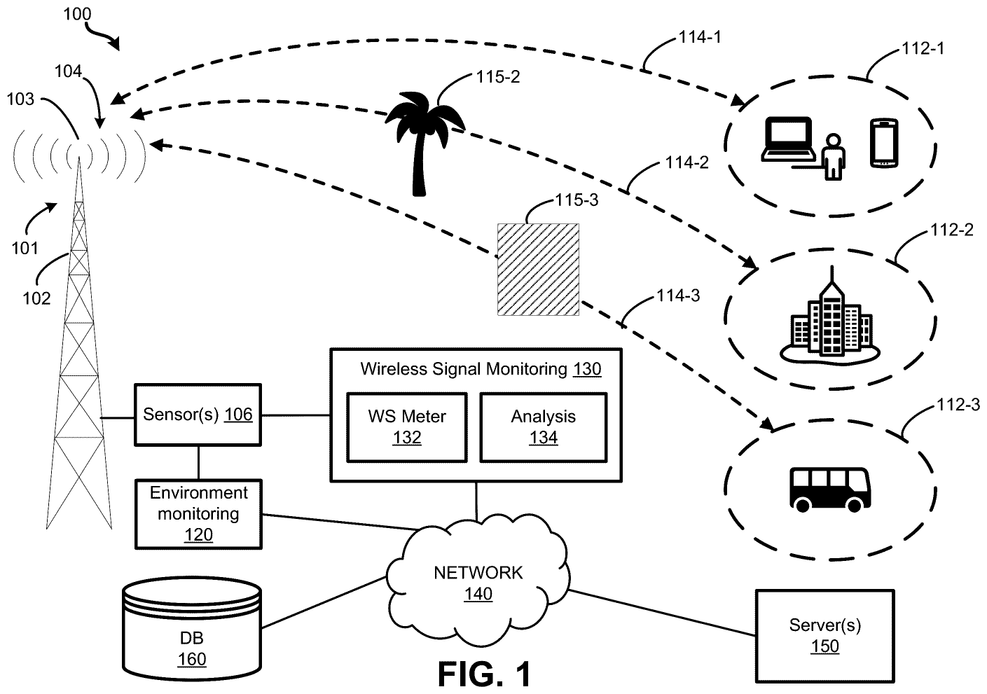

FIG. 1 is a schematic diagram illustrating an example wireless communication system 100. The wireless communication system 100 includes a cell site 101, one or more sensors 106 attached to or in proximity to the cell site, an environment monitoring system (EMS) 120 in communication with the one or more sensors 106, a wireless signal monitoring system (WSMS) 130, a communications network 140, one or more servers 150, and one or more databases 160.

The wireless communication system 100 includes a cell site (also referred to as a “wireless node”) 101. The term “wireless node” used herein broadly encompasses a radio tower, a cell site, a base station, a 5G tower, a 5G site, a 5G node, or other types of sources of wireless signals. The cell site 101 may include a physical structure 102 and a wireless signal transmitter 103 mounted on the physical structure 102. Various form of the physical structure 102 may be used to support the transmitter 103, for example, radio towers, antennas or an antenna array mounted on building roofs, sides, pools, street poles, or the like. When the wireless node is an 5G tower, it may include any known and/or later arising cellular and/or mobile communications technologies, systems and components configured for use with 5G, licensed radio frequency (RF), or unlicensed RF. The cell site 101 is configured to generate a wireless signal and transmit the wireless signal to a wireless signal receiver to establish a wireless communication.

As used herein, a wireless signal may be defined in terms of one or more coverage areas. Herein, a “coverage area” or “usable range” refers to a geographic area centered around a cell site where a wireless communication may be established between the wireless signal transmitter and a wireless signal receiver located in the coverage area. A typical coverage radius of a cell site is about 1 to about 10 miles (i.e., about 1.6 to about 16 kilometers). In dense urban environments, a cell site usually reaches about 0.25 miles to about 1 mile (e.g., about 0.4 to about 1.6 kilometers) before handing off a user's connection to another nearby cell site. Notably, the wireless signal coverage area may also depend, at least in part, on the frequency band of the wireless signal. In general, higher frequency wireless signals carry voice, video, and data traffic to-and-from cell sites over a shorter distance before dissipating. Whereas lower frequency wireless signals travel a greater distance, providing cell site with a larger coverage range (or radius). For example, the Low-Band wireless signal transmitted from a cell site may cover a range up to a radius of 10 miles (i.e., 16 kilometers) relative to the cell site; a Mid-Band wireless signal transmitted from a cell site may cover a range up to a radius of from 1 to 5 miles (i.e., from 1.6 to 9 kilometers) relative to the cell site; a High-Band wireless signal transmitted from a cell site may cover a range up to a radius of from 50 to 2,000 feet (i.e., from 15 to 600 meters) relative to the cell site.

As illustrated in FIG. 1, the transmitter 103 may be mounted on a top portion of the physical structure 102 at a height (H) relative to the ground. The heigh (H) may be from about 10 to about 500 feet. The cell site 101 may establish a broadcast network 105 covering an area in a range centered around the cell site 101 as mentioned above. In operation, the cell site 101 generates a wireless signal 104 and transmit the wireless signal 104 from the transmitter 103 to various receiving locations (e.g., 112-1, 112-2, 112-3, etc., collectively as 112) within the coverage area around the cell site 101. For example, the receiving location 112-1 represents an outdoor area or region (e.g., a part of a walking trail, a part of a square, a part of a park, a part of a recreational area, etc.), where individual users use personal computing devices or mobile devices to receive the wireless signals 104 transmitted from the cell site 101. The receiving location 112-2 represents a building or a construction structure (e.g., home, office, shop, warehouse, etc.), within which a receiver may receive the wireless signal 104 transmitted from the cell site 101. The receiving location 112-3 represents a traffic area or moving or non-moving vehicle within the traffic area (e.g., a part of a traffic road, a motor vehicle, a transportation tool, an autonomous vehicle, etc.). It is noted that the locations 112-1, 112-2, and 112-3 are illustrative scenarios and not intended to be limiting, other receiving locations within the coverage area around the cell site 101 are also possible.

Various line of sight (LOS) wireless communications (e.g., 114-1, 114-2, and 114-3, etc., collectively as 114) can be established respectively between the transmitter 103 and the receiving locations 112. In the illustrated example, the term “line of sight (LOS)” used herein refers to a straight-line or near straight-line communication path between a wireless signal transmitter (e.g., a transmitting antenna) and a wireless signal receiver (e.g., a receiving antenna). In general, there are three main categories of LOS, the first type being “full LOS” (e.g., the LOS 114-1), where no obstacles reside between the two antennas. The second type of LOS is called “near LOS” (e.g., the LOS 114-2), which includes partial obstructions such as treetops (e.g., the obstacle 115-2) between the two antennas, and the wireless signals 104 can still pass through the obstruction but are affected by the obstruction (e.g., with reduced signal quality). The third type of LOS is “no LOS” or “NLOS” (e.g., the LOS 114-3, where full obstructions (e.g., the obstacle 115-3) exist between the two antennas and the wireless signals is completely or nearly completely blocked by the full obstructions. The obstruction to the path of LOS may also depend, at least in part, on the physical characteristics and properties of the obstacle.

In the illustrated example of FIG. 1, the EMS 120 is configured to monitor a neighborhood environment around the cell site 101, detect an obstacle that potentially causes an obstruction of the LOS between the transmitter 103 and a selected location 112, and estimate/predict the impact or influence of the obstruction. The EMS 120 may be in communication with the one or more sensor(s) 106. In alternative embodiments, the one or more sensor(s) 106 are a component of the EMS 120. The one or more sensor(s) 106 are mounted on the physical structure 102 of the cell site 101, or alternatively set up in proximity to the cell site. The one or more sensor(s) 106 are configured to map the three-dimensional (3D) neighborhood environment around the cell site, sense an object in the environment, measure a characteristic of the object or the environment, measure a distance between the object and the sensor, and/or calculate a distance between the transmitter and the object. The one or more sensors 106 may include one or more of: a temperature sensor, a disturbance detection sensor, an energy sensor, a noise sensor, a vibration sensor, a weather sensor, an image sensor, a RADAR (i.e., a “radio detection and ranging”) sensor, or a LIDAR (i.e., a “light detection and ranging”) sensor. The one or more sensors 106 may generate cell site environment data regarding the various characteristics and aspects of the environment around the cell site and the obstacles that potentially obstruct the path of LOS or interfere with the LOS wireless transmission.

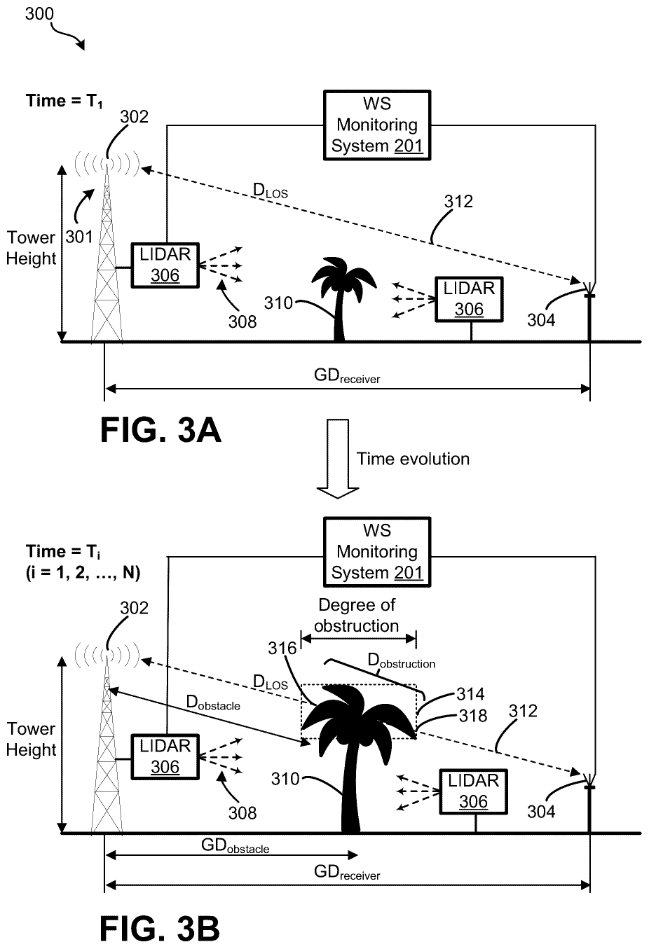

In some embodiments, the one or more sensor(s) 106 include a LIDAR sensor. LIDAR is based on a technique for determining ranges (variable distance) by targeting an object or a surface with a laser beam (e.g., the light beam 308 shown in FIG. 3) and measuring the time for the reflected light to return to the receiver. LIDAR can also be used to make digital 3D representations of areas on the earth's surface by varying the wavelength of light. The LIDAR sensor may use ultraviolet, visible, or near infrared light to image objects in the neighborhood environment around the cell site 101. The LIDAR sensor can target a wide range of materials of the object, including non-metallic objects, buildings, plants, animals, rocks, rain, chemical compounds, aerosols, clouds, etc. The LIDAR sensor can employ a narrow laser beam can map physical features with very high resolutions (e.g., at a 30-centimeter resolution) and very high positional accuracy and precision. For example, the LIDAR sensor can measure a precise distance between the object (or a component) thereof and the LIDAR sensor.

In some embodiments, the LIDAR sensor is mounted on the physical structure 102 of the cell site 101. In some embodiments, the LIDAR sensor is established in a proximity to the cell site 101 (e.g., in a radial range from 1-20 feet). In other embodiments, multiple LIDAR sensors in operative conjunction can be established around the cell site to monitor the environment (e.g., the LIDAR sensors 306 of FIGS. 3A-3B) in a broader range with enhanced precision and accuracy.

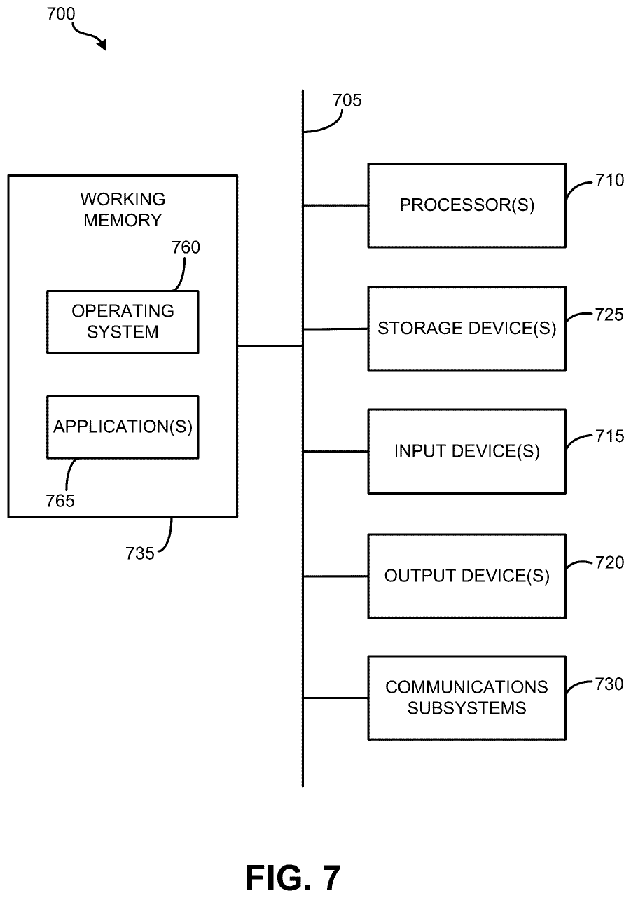

The cell site environment data obtained by the sensor(s) 106 may be received by the EMS 120. The EMS 120 may include computing resources (not shown) or employ a general-purpose computer device (e.g., the computer device of FIG. 7) to process the cell site environment data and monitor the cell site environment in a real-time manner. Alternatively, the EMS 120 may be in communication with the server(s) 150 and the database(s) 160 through the communication network 140, and the server(s) 150 and the database(s) 160 may be used to process the cell site environment data for the EMS 120.

The EMS 120 can be used to detect and identify a potential obstacle that likely causes an obstruction to a path of the LOS or an interference with the LOS wireless transmission between the transmitter 103 and a target receiving location 112. For example, the EMS 120 may calculate a distance between the obstacle 115-2 or 115-3 and the transmitter 103 of the cell site 101, based on the known position of the transmitter 103 relative to the LIDAR sensor and the measured distance between the LIDAR sensor and the obstacle. Further, the LIDAR can be used to qualitatively, semi-quantitatively, or quantitatively determine the degree of obstruction or interference caused by the obstacle (e.g., the length/size/area of the obstruction, the ratio of the obstruction length relative to the total length of the LOS path, etc.).

The EMS 120 can also be used to monitor a change of the state of the obstacle (e.g., an obstruction state) over time, based on the cell site environment data. For example, the obstacle may be a growing plant such as a tree, and the EMS 120 may monitor the tree growth over time and/or the size and density change of the treetop and generate a model of tree growth rate or treetop growth rate, and generate a model of obstruction state based on the tree growth rate. The model of obstruction state generated by the EMS may be used to estimate and predict the signal quality of the wireless signals transmitted along the LOS, which will be described in more details below.

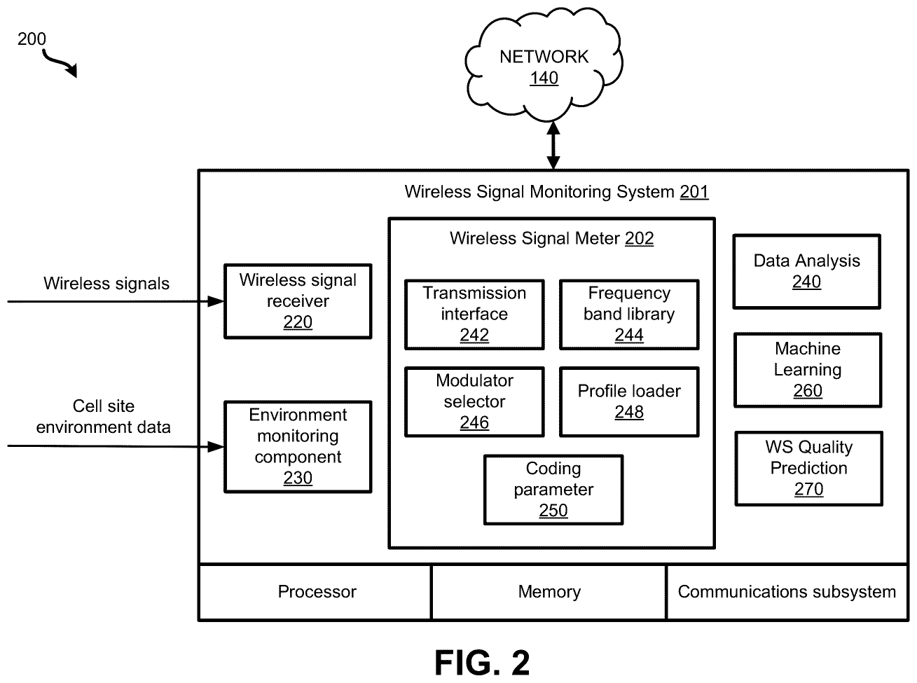

The WSMS 130 is configured to monitor the signal quality of the wireless signal 104 transmitted by the transmitter 103. The WSMS 130 includes a wireless signal meter 132 and an analytics component 134. The wireless signal meter 132 may be a programed multiband power meter configured to measure the signal strength and other parameters, characteristics, or aspects regarding the wireless signal 104, including but not limited to signal-to-noise ratio (SNR)), wavelength, bandwidth, or power level, etc. Signal measurement data can be generated by the wireless signal meter 132 and processed by the analytics component 1134. The wireless signal meter 1322 may collect the signal measurement data from the incoming transmissions and send the signal measurement data periodically or incrementally or in a real-time manner to the communications network 140. The analytics component 134 can further analyze the signal measurement data, determine the signal quality of the wireless signals, correlate the signal quality and the obstruction state of the detected obstacles, and predict the wireless signal performance. More examples of the WSMS 130 and the function thereof will be described below with reference to FIG. 2 and FIG. 3.

Like the EMS 120, the WSMS 130 may also include computing resources (not shown) or employ a general-purpose computer device (e.g., the computer device of FIG. 7) to support the processing function of the wireless signal meter 132 and the analytics component 134 (e.g., processing and analyzing the signal measurement data). Alternatively, the WSMS 130 may be in communication with the server(s) 150 and the database(s) 160 through the communication network 140, and the server(s) 150 and the database(s) 160 may be used to process and analyze the signal measurements data for the WSMS 130.

FIG. 2 is a schematic diagram illustrating an example system 200 in accordance with various embodiments. The system 200 includes a WSMS 201 in communication with a communications network 140. The WSMS 201 integrates the EMS 120 and the WSMS 130 of FIG. 1 in one system. In the illustrated example, the WSMS 201 includes, among other components, a wireless signal meter 202, a wireless signal receiver 220, an environment monitoring component 230 (e.g., an example representing the EMS 120 of FIG. 1), a data analysis component 240, a machine learning component 260, and a wireless signal quality prediction component 270. The WSMS 201 may further include server components such as processor, memory, and communication interface as described below with reference to FIG. 7.

The wireless signal receiver 220 may be placed in a selected location 112 in the coverage area of the cell site 101 (FIG. 1) for receiving wireless signals 104 transmitted from the transmitter 103 of the cell site 101. The environment monitoring component 230 is configured to receive the cell site environment data generated by the sensor(s) 106.

In some embodiments, the wireless signal meter 202 measures parameters of wireless signals received on a variety of frequency bands. An operator may select a module associated with a frequency band to meter wireless signals. In some embodiments, the wireless signal meter 202 may determine the frequency of the received wireless signal and select a module based on the associated frequency band. In another embodiment, the modules are programed (e.g., program-defined radio (SDR)) which an operator can select or the wireless signal meter 202 can select and load for metering. In another embodiment, the modules are hardware which the operator can connect to the wireless signal meter 202 based on the determined frequency. The wireless signal meter 202 may perform tuning once the module is selected for the determined frequency band. For example, the wireless signal meter 202 detects a wireless signal transmission from the transmitter 103 at 25 GHz. The user may select a module associated with a frequency band that covers that frequency range (e.g., a high frequency range of 10 GHZ to 50 GHz). After the operator selects the frequency band that covers 25 GHz, the wireless signal meter 202 may tune the module to 25 GHz to measure the signal quality of the wireless signal from the transmitter 103. In some embodiments, the wireless signal meter 202 may be configured to reject detection of signals which are outside of the frequency range of the selected frequency band.

In the illustrated example of FIG. 2, the wireless signal meter 202 can include, among other components, a transmission interface 242, a frequency band library 244, modulator selector 246, profile loader 248, and a coding parameter 250. The wireless signal meter 202 may transfer the received wireless signal to the transmission interface 242 and determine the frequency associated with the wireless signal. For example, the wireless signal meter 202 may have embedded antennas and external antenna ports. The embedded antennas may receive the wireless signal transmission on frequency bands from the transmitter 103. The external antenna ports may allow for measurements to be taken for a variety of scenarios. One example is convenience for testing in which signal measurements can be taken indoors by connecting to an outdoor, installed antenna. Another example is frequency band compatibility so that measurements can be taken from larger antennas than those embedded in the meter itself in order to better receive lower frequencies.

In some embodiment, the wireless signal meter 202 may select a frequency band from frequency band library 244 with a frequency range that correlates to the determined frequency.

For example, the wireless signal meter 202 receives a transmission of wireless signals of a mixed frequency bands from a 5G source and determines the frequency of the transmission is 25 GHz. The wireless signal meter 202 may select a frequency band (e.g., high frequency band with a frequency range of 3-30 GHZ) that includes 25 GHz within the frequency range of the frequency band. After selecting the frequency band based on the determined frequency of the transmission, the modulator selector 246 may select a module to measure the signal quality of the transmission. For example, the modulator selector 246 may select a module for measuring the signal quality of signals within the frequency range of 3-30 GHz based on the received signal having a frequency of 25 GHz. In some cases, the selected module may reject the detection of signals outside of the frequency range of 3-30 GHz.

In another embodiment, an operator may select the module to measure the signal quality of the transmission. The selection of a module may be made based on factors such as frequency compatibility, pre-assigned data collection parameters, or availability of modules loaded onto the wireless signal meter 202. There may be various modes of operation that dictate module selection. For example, in one mode, the operator can designate which specific frequencies to measure through the transmission interface 242, and the wireless signal meter 202 would then select a compatible module. In an alternate mode, a pre-configured or designated setting for specific frequency ranges could be assigned. In another alternate mode, the wireless signal meter 202 could perform a universal frequency scan (e.g., 50 MHz to 50 GHz) and select a compatible module as required. The modular architecture of the wireless signal meter 202 may allow for investing in modules for specific frequencies as required.

The profile loader 248 may load profiles for measuring signal parameters based on the selected module for the determined frequency. For example, the profile loader 248 may load a first profile for measuring the signal quality of a signal received at 25 GHz or a second profile for measuring the SNR of the signal received at 25 GHz.

The wireless signal meter 202 may adjust coding parameters 250 in the selected module to increase accuracy of the measurement. For example, the wireless signal meter 202 may adjust coding parameters 250 to capture multiple measurements of the signal quality of a signal at 25 GHz. In some cases, the wireless signal meter 202 may adjust the coding parameters 250 to switch between measuring different signal parameters, such as signal quality or power level. The wireless signal meter 202 may adjust the coding parameters 250 to tune to other frequency levels. For example, the received signal is determined to have a frequency of 25 GHZ, and the wireless signal meter 202 may adjust the parameters 250 to measure signal parameters at 24.25 GHz or 25.4 GHz. Adjusting coding parameters may change the orientation of the antennas (e.g., the wireless signal receiver 220) receiving the wireless signal. Reception of signals may vary by transmission and different coding parameters allow the wireless signal meter 202 to analyze the entire bandwidth of the wireless signal. In the 24.25 GHz example above, a wireless signal that spans across the 25 GHz frequency may exhibit different behaviors or errors across its entire channel bandwidth. By taking a detailed view (e.g., microscopic view) of the signal at 24.25 GHz through 25.40 GHz, the wireless signal meter 202 can provide additional information for signal quality determination at each smaller band of the entire frequency span.

In some embodiments, the wireless signal meter 202 is operatively connected via wireless or wired connection to module for frequency band 1, a module for frequency band 2 264, and a multitude of modules for frequency bands up to a module for frequency band N. The frequency bands may range from 3 kHz to 300 GHz and the wireless signal meter 202 may support metering for wireless signal transmission on every frequency band. In an embodiment, the modules are hardware and connected to the wireless signal meter 202. The frequency band 1 through frequency band N may be respective correspond to a full span of the radio frequency, e.g., ranging from a very low frequency (VLF) band with a frequency range of 3-30 kHz, a low frequency (LF) band with a frequency range of 30-300 kHz, a medium frequency (MF) band with a frequency range of 300-3,000 kHz, a high frequency (HF) band with a frequency range of 3-30 MHz, a very high frequency (VHF) band with a frequency range of 30-300 MHz, an ultra-high frequency (UHF) band with a frequency range of 300-3,000 MHz, a super high frequency (SHF) band with a frequency range of 3-30 GHz, and an extremely high frequency (EHF) band with a frequency range of 30-300 GHz. In an embodiment, the wireless signal meter 202 may receive a wireless transmission at a frequency of 25 GHz from a 5G source (e.g., the transmitter 103 of the cell site 101) and select a module which may reject detection of signals outside of the frequency range of 24.25 GHz to 52.6 GHz. In another embodiment, the wireless signal meter 202 may receive a wireless signal transmission at a frequency of 3.8 GHz and select a module which may reject detection of signals outside of the frequency range of 3.7 GHZ to 4.2 GHz.

In some embodiment, the wireless signal meter 202 may tag the signal measurements with a geolocation (e.g., each measurement can be paired to geo-located information, such as a latitude or longitude, street address, subscriber location, or other regional identifier of subscriber). The wireless signal meter 202 may convert the measurements into data packets and transmit the data packets to the data analysis component 240. In some embodiments, the wireless signal meter 202 may tag the signal measurements with an obstruction state of an identified obstacle in the environment around the cell site, based on the cell site environment data received by the environment monitoring component 230. In some embodiments, the wireless signal meter 202 may tag the signal measurements of the received wireless signals with an obstruction state of an identified obstacle at each frequency band selected by the modulator selector 246.

The data analysis component 240 can further calculate a wireless signal quality score based on the wireless signal data measured by the wireless signal meter 202. A pre-established algorithm may be used to take into account relevant factors, such as signal strength value, signal-to-noise ratio, power level, signal strength stability, external factors such as weather, temperature, air quality, etc., in the process of calculation. An averaged wireless signal quality score may be calculated for a plurality of measurements of the wireless signals in different occasions. Further, a separate and distinct wireless subscore may be calculated for each frequency band of the wireless signal of mixed frequency bands. The wireless signal quality scores and subscores are quantitative or semi-quantitative representation of the performance of the wireless transmission generated by the cell site. A reference or standard may be predetermined to quantitatively correlate the wireless signal quality score and the transmission performance. For example, a quality score of 80 (on a 100 scale) and above represents a good transmission performance; a quality score of 60 to 79 represents an acceptable transmission performance; a quality score of below 60 represents a failure.

The data analysis component 240 may further determine if the wireless signal quality is acceptable or complies with agency/regulation requirement, by comparing with the calculated wireless signal score with a predetermined standard of reference score. In some embodiments, the data analysis component 240 may tag the obstruction state of the identified obstacle to the signal quality score of the wireless signal that is obstructed or interfered by the obstacle. In some embodiments, the data analysis component 240 may map the wireless signal quality score for the environment around a cell site to generate a 3D profile of the wireless signal quality in the environment, monitor the wireless signal quality score of the environment over time, and track change of the wireless signal quality score against the obstacle or an obstruction state thereof. In some embodiments, the data analysis component 240 may calculate a signal quality loss of the wireless signal obstructed or interfered by the obstacle in the LOS at a particular obstruction state. In some embodiments, the signal quality loss includes a signal strength loss defined by the difference between the signal strength values measured at different obstruction states. The data analysis component 240 may track the change of the signal quality loss against the change of the obstruction state over time. In some embodiments, the data analysis component 240 correlate the degree of obstruction (e.g., obtained from the obstruction state of the obstacle) with the wireless signal quality score and/or the signal quality loss over time.

The WSMS 201 may further include a machine learning component 260 configured to apply advanced data science techniques such as artificial intelligence or machine learning to correlate the cell site environment (e.g., obstruction state of the obstacle) with the wireless signal quality score, based on the analysis of a voluminous amount of data. The machine learning component 260 may train a machine learning model, which can be utilized by the wireless quality prediction component 270 to predict transmission performance the cell site, for example, an obstruction state of an identified obstacle, a wireless signal parameter of the transmission from the cell site, and/or a wireless signal quality score at a particular frequency band in a future time point. The machine learning component 260 may further predict a future time point at which a degree of obstruction of an existing obstacle will exceed a maximum level. The machine learning component 260 may also calculate or estimate a future time point at which the predicted wireless signal quality score or transmission performance will be drop below a predetermined threshold level. The machine learning component 260 may also recommend an action to take to remedy to mitigate the obstruction and/or remedy performance loss, based on the machine learning model. More examples of implementation of the WSMS 201 will be described below with reference to FIGS. 3-6.

FIG. 3A and FIG. 3B are schematic diagrams illustrating an example system 300 and various stages thereof in a process for implementation of the WSMS 201 in accordance with some embodiments. In the illustrated example, the system 300 includes a cell site 301, a wireless signal transmitter 302 mounted on the cell site 301, a wireless signal receiver 304 placed in a selected location within a coverage area of the cell site 301, a LIDAR sensor 306 mounted on the cell site 301, and an identified obstacle 310 that potentially obstructs a LOS 312 between the transmitter 302 and the receiver 304. The LIDAR sensor 306 generates a light beam 308 for mapping the environment, measuring the 3D profile of the obstacle 310, and detecting the various range parameters regarding the obstacle 310.

FIG. 3A illustrates a stage of the system 300 at a time point T₁, at which the obstacle 310 is identified to be a potential obstruction to the path of LOS 312 but yet not obstructing the path of LOS 312. The LIDAR 306 can generate cell site environment data at T₁, the cell site environment data indicating a first obstruction state of the obstacle 310 (e.g., the ground distance (GD_{obstacle}) between the cell site 301 and the obstacle 310, the ground distance (GD_{receiver}) between the transmitter 302 and the receiver 304, a height of the obstacle at T₁, a profile of the treetop if the obstacle is a tree, etc.). The WSMS 201 can further process the cell site environment data to characterize the obstruction state, for example, calculate a degree of obstruction to the path of the LOS, as mentioned above. At T₁, the degree of obstruction is zero or near zero.

FIG. 3B illustrates a stage of the system 300 at a time point Tᵢ (i=2, 3, 4, . . . , N along the direction of time evolution). At time point Tᵢ, the obstacle 310 may evolve to the i^{th} obstruction state indicating an obstruction to the LOS and/or an interference with the signal transmission along the LOS. The WSMS 201 can process the cell site environment data generated at Tᵢ to characterize the i^{th} obstruction state, for example, calculate a degree of obstruction to the path of the LOS, as mentioned above.

The degree of obstruction contributed by the obstacle 310 may be determined by a pre-defined rule or principle (e.g., implemented by a pre-established model or algorithm). As one example, a process for determining the degree of obstruction may include one or more of the following actions. The transmitter 302 and the receiver 304 are positioned, and their respective geographic positions are determined. A distance from the LOS between the transmitter 302 to the receiver 304 (i.e., D_{LOS}) is calculated, based on the relative geographic positions of thereof. Next, the ground position, height, and physical profile of the obstacle 310 can be obtained by the LIDAR sensor 306, and the range between the LIDAR sensor 306 and the obstacle 310 can be precisely determined based on the measurements data generated by the LIDAR sensor and processed. Based on the relative position of the LIDAR sensor 306 and the transmitter 302, the distance from the transmitter 302 to each part of the obstacle 310 can be calculated, based on the height and the physical profile of the obstacle 310. For example, it can be determined if the obstacle 310 has an obstructing part 314 that exists in the path of the LOS 312. If the obstructing part 314 is determined to exist, a starting point 316 and an ending point 318 of the obstructing part 314 along the LOS can be ascertained. Accordingly, a distance from the starting point 316 to the ending point 318 (i.e., D_{obstruction}) of the obstructing part 314 can be calculated. The degree of obstruction contributed by the obstacle 310 may be obtained by the ratio of the D_{obstruction} to the D_{LOS} (i.e., by a formula: degree of obstruction=D_{obstruction}/D_{LOS}). In some embodiments, other factors such as the D_{obstacle}, GD_{obstacle}, GD_{receiver}, the material and density of the obstructing part 314, and the shape of the obstructing part, etc., may also be taken into account (e.g., by applying a weight each thereof to the formula provided above) to determine the degree of obstruction. It should be noted that the above example is for illustrative purpose only and is not intended to be limiting, other examples for determining the degree of obstruction and/or the obstruction state of the obstacle may also be possible in alternative embodiments.

A wireless signal transmission test can be performed. In the test, a set of test wireless signals can be generated by the cell site and transmitted from the transmitter 302 to the receiver 304 along the LOS without obstruction (e.g., a degree of obstruction close to zero) of the obstacle 310. In turn, the WSMS 201 can be used to measure the set of test wireless signals and calculate a first wireless signal quality score. The first wireless signal quality score may be used as a reference or standard score (i.e., in the absence of obstruction in the path of LOS). In some embodiments, the set of test wireless signals have a mixed frequency bands (e.g., a low-band, a mid-band, and a high-band, or a selected range of frequency range, etc.), and the WSMS 201 can calculate a reference signal quality score for each frequency band. In some embodiments, the wireless signals are 5G signals, and the WSMS 201 can calculate a reference signal quality score for the 5G signals. In alternative embodiments, a reference or standard wireless signal quality score can be predetermined, for example, based on regulatory agency requirements or commonly accepted consumer expectations.

The WSMS 201 may be used to continuously monitor the environment and the transmission performance regarding the cell site 301 over time. For example, a plurality of time points can be selected along the direction of time evolution, and the WSMS 201 may be used to obtain an obstruction state of the obstacle and the wireless signal quality score for the cell site at each of these selected time points. For example, at time Tᵢ(i=2, 3, 4, . . . , N along the direction of time evolution) as shown in FIG. 3B, the obstacle 310 evolves to the i^{th} obstruction state as mentioned above. The LIDAR 306 is used to map the profile of the obstacle 310 and measure the characteristics of the i^{th} obstruction state (e.g., the ground distance (GD_{obstacle}) between the cell site 301 and the obstacle 310, the distance (D_{obstacle}) between the transmitter 302 and the obstructing part 314 of the obstacle 310, the height of the obstacle 310 at Tᵢ, the degree of obstruction relative to the LOS distance (D_{LOS}), etc.). The WSMS 201 can further generate an obstruction progression model describing a pattern of the change or dynamics of obstruction state over time regarding the obstacle. As an example, when the obstacle is a growing tree, a model of growth rate of the tree can be generated; when the obstacle is a new construction, a model for progression rate of the new construction can be generated.

The WSMS 201 can be further used to calculate an i^{th} wireless signal quality score for the cell site at Tᵢ in a similar manner described above. In this way, the WSMS 201 can monitor the signal quality score over time and generate a profile of the signal quality score for the selected location. Further, the WSMS 201 map the i^{th} wireless signal quality scores against the i^{th} obstruction state of the obstacle (i=1, 2, . . . , N) and correlate the signal quality with the obstruction state in a selected time span. As mentioned above, machine learning algorithms may be employed to facilitate data analysis. In some embodiments, a machine learning model can be trained by the WSMS 201 using the cell site environment data, the wireless signal measurements data, and the wireless signal quality scores.

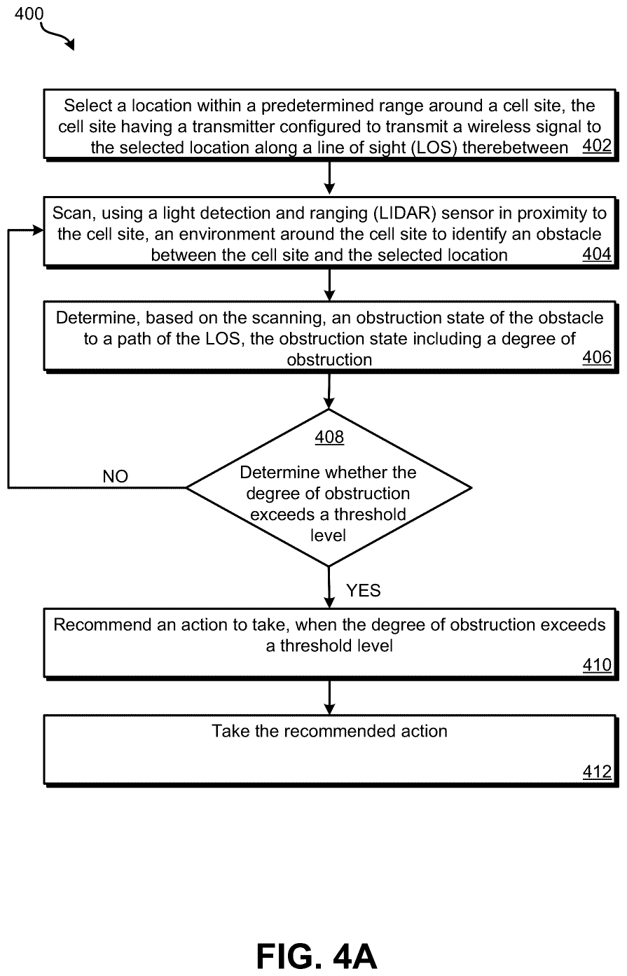

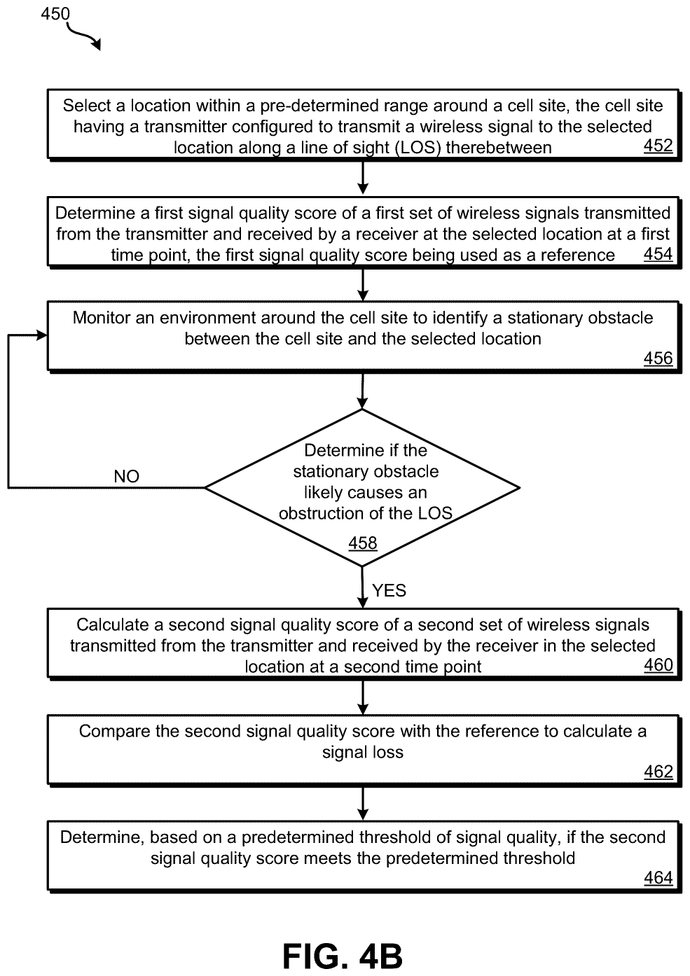

FIG. 4A is a flow chart diagram illustrating an example method 400 for monitoring wireless signal performance. The method 400 may be employed by using the systems and processes described in the present disclosure. At 402, a location within a predetermined range around a cell site is selected. The cell site has a transmitter configured to transmit a wireless signal to the selected location along a LOS therebetween. At 404, an environment around the cell site to identify an obstacle between the cell site and the selected location is scanned using LIDAR in proximity to the cell site. Cell site environment data can be generated based on the scanning and received.

At 406, a degree of obstruction of the obstacle to a path of the LOS is determined based on the scanning and the received cell site environment data. The degree of obstruction is characterized by a ratio of an obstruction distance of the obstacle to a total distance of the LOS and the obstruction distance being characterized by a dimension of the obstructing part along the path of the LOS. In some embodiments, an obstruction state of the obstacle is obtained or determined. Determination of the obstruction state may include: measuring a distance between the obstacle and the cell site using the LIDAR sensor; calculating a distance between the obstacle and the transmitter; calculating the total distance of the LOS; determining if the obstacle has an obstructing part that exists in a path of the LOS; in response to the existence of the obstructing part, determining the obstruction distance of the obstacle; and calculating the degree of obstruction.

In some embodiments, a first time point (T₁) is selected and a first obstruction state of the obstacle at T₁ is determined; a second time point (T₂) is selected and a second obstruction state of the obstacle at T₂ is determined; and the first obstruction state and the second obstruction state are compared to determine a change of the obstacle.

At 408, a determination is made as to whether the degree of obstruction exceeds a pre-determined threshold level. At 410, in response to the determination that the degree of obstruction exceeds a pre-determined threshold level, an action is recommended to mitigate the degree of obstruction. The action may include remedial measures such as alteration of one or more operational parameters of the cell site, adjustment of transmitter antenna, mitigation/removal of the obstruction, wireless signal enhancement in the selected location, and so on. At 412, the recommended action is taken.

FIG. 4B is a flow chart diagram illustrating an example method 450 for monitoring wireless signal performance. The method 450 may be employed by using the systems and processes described in the present disclosure. At 452, a location within a predetermined range around a cell site is selected. The predetermined range is within the coverage area around the cell site. The cell site has a transmitter configured to transmit a wireless signal to a wireless signal receiver placed in the selected location along a LOS between the transmitter and the receiver. At 454, the first signal quality score of a first set of wireless signals transmitted from the transmitter and received by the receiver at the selected location is determined from a first signal test at a first time point. The first signal quality score may be used as a reference. At 456, an environment around the cell site is monitored to identify an obstacle between the cell site and the selected location. In some embodiments, one or more LIDAR sensors mounted on the cell site are used to monitor the environment and measure the characteristics of the obstacle.

At 458, a determination is made on the likelihood of obstruction to the path of the LOS by the obstacle. Multiple factors may be considered in the determination, for example, the distance between the obstacle and the cell site, the distance between the obstacle and the selected location, the degree of obstruction to the path of the LOS, the physical property and material composition of the obstacle, and so on. In some embodiments, a process is performed to make the determination, and the process includes: measuring the distance between the obstacle and the LIDAR sensor, calculating the distance between the obstacle and the transmitter, based on the relative position of the transmitter on the cell site and the LIDAR sensor, calculating the LOS distance between the transmitter and the selected location, calculating a degree of obstruction, based on the ratio of the obstructed distance along the LOS and the total LOS distance, and determining if the ratio of the degree of obstruction is above a predetermined threshold, the predetermined threshold indicating that the obstacle likely obstructs the path of the LOS. If an outcome of the determination is negative, the method proceeds to 456, and monitoring the environment around the cell site continues. If the outcome of the determination is positive, the method proceeds to 460.

At 460, a second signal quality score of a second set of wireless signals transmitted from the transmitter and received by the receiver in the selected location is calculated from a second test at a second time point later than the first time point. The second set of wireless signals may be identical to the first set of wireless signals. The second signal quality score in calculated in a similar manner as the first signal quality score. In some embodiments, the first and second sets of wireless signals may include a plurality of frequency bands, and the frequency bands can be determined, and each of the first and second wireless signal quality scores may further include a plurality of subscores respectively corresponding to the plurality of frequency bands. At 462, the second signal quality score is compared with the first signal quality score (i.e., the reference) to calculate a loss of signal quality caused by the obstacle. In some embodiments, the loss of signal quality is represented by the loss of the signal strength defined by the difference between the first and the second signal strength values.

In some embodiments, a plurality of signal tests is performed with respect to a plurality of time points along a direction of time evolution. The tests may be performed under the same or similar conditions (e.g., same transmission power, same frequency bands, same local weather, etc.) to obtain each i^{th} wireless signal quality score (i=1, 2, . . . , N) with respect to each i^{th} time point (Tᵢ). A profile of the wireless signal quality score over time may be generated by plotting the plurality of wireless signal quality scores against the plurality of time points. In this way, the transmission performance regarding the cell site at each frequency band can be monitored over time. In some embodiments, the wireless signal performance of the entire coverage area around the cell site can be monitored and mapped by selecting multiple locations representing the whole coverage area around the cell site and performing the method 450 for each of the multiple locations. At 464, a determination is made on if the wireless signal performance meets performance requirement, based on a pre-determined threshold level.

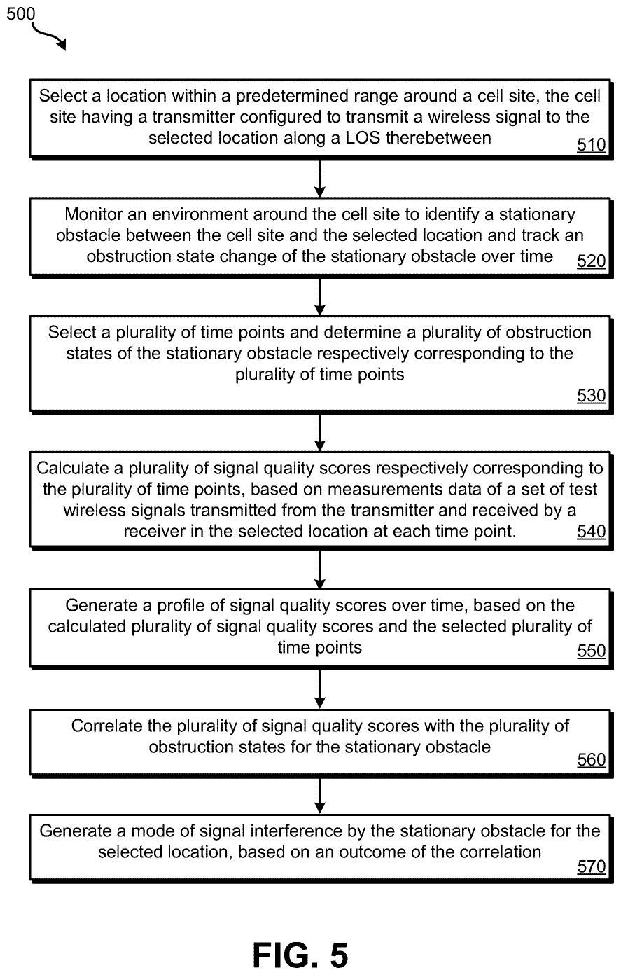

FIG. 5 is a flow chart diagram illustrating another example method 500 for monitoring wireless signal performance. The method 500 is a variation of the method 400 of FIG. 4. At 510, a location within a predetermined range around a cell site is selected. The cell site has a transmitter configured to transmit a wireless signal to a wireless signal receiver placed in the selected location along a LOS between the transmitter and the receiver. At 520, an environment around the cell site is monitored (e.g., by one or more LIDAR sensors) to identify an obstacle between the cell site and the selected location. An obstruction state of the obstacle is tracked over time by the LIDAR sensors. In some embodiments, the obstruction state is characterized by a degree of obstruction, based on a ratio of the obstructed distance of an obstructing part of the obstacle along the LOS and a total LOS distance (D_{LOS}) (i.e., between the transmitter of the cell site and the selected location). Other factors such as D_{obstacle}, D_{receiver}, GD_{obstacle}, GD_{receiver}, and the physical properties of the obstacle (e.g., density, composition material, surface pattern, 3D shape, etc.) may also be taken into account to characterize the obstruction state.

At 530, a plurality of time points (Tᵢ, i=1, 2, . . . , N) along a direction of time evolution is selected, and a plurality of obstruction states of the obstacle is determined, respectively corresponding to the plurality of selected time points (e.g., the i^{th} obstruction state corresponds to the i^{th} time point (Tᵢ)). In some embodiments, a first obstruction state corresponding to Tᵢ is obtained and used as a reference indicating no obstruction to the path of the LOS (e.g., the degree of obstruction is zero, near zero, or below a predetermined threshold level). In some embodiments, a model of obstruction can be generated by plotting the plurality of obstruction states. In some embodiments, multiple models of obstruction can be generated, each model describing a particular characteristic of the obstacle over time.

At 540, a plurality of wireless signal quality scores is calculated, with respect to the plurality of selected time points. In some embodiments, a process for calculation of the plurality of wireless signal quality scores is used, and the process includes: transmitting a set of test wireless signals from the transmitter of the cell site to the receiver placed in the selected location at each of the selected time points; measuring parameters of the wireless signal received by the receiver to obtain measurements data with respect to each of the selected time points (Tᵢ), the measurements data including a signal strength of the wireless signal received by the receiver; process the measurements data to calculate an i^{th} signal quality score with respect to each of the selected time points (Tᵢ), based on a pre-established algorithm that takes into account a predetermined list of factors. In some embodiments, the set of test wireless signals has only one frequency band (e.g., a high-band, a mid-band, or a low-band, or a selected frequency range). In some embodiments, the set of test wireless signals have mixed frequency bands, and the process may further include determining the frequency bands of the test wireless signal received by the receiver, and calculating an i^{th} wireless signal quality subscore for each frequency band (or a selected frequency range) of the wireless signals measured at each of the selected time points (Tᵢ).

At 550, a profile of the wireless signal performance over time is generated by plotting the plurality of wireless signal quality scores against the plurality of time points. In some embodiments, a plurality of profiles can be generated, each profile corresponding to each of the frequency bands of the test wireless signals.

At 560, a relationship between the wireless signal quality scores and the obstruction states is determined. In some embodiments, the plurality of signal quality scores is correlated with the plurality of obstruction states of the obstacle. At 570, a model of signal quality by the obstacle is generated, based on an outcome of the correlation between the signal quality scores and the obstruction states. In some embodiments, multiple models may be generated with respect to each characteristic of the obstruction state. The model provides valuable insights on the impact of the obstacle on the obstruction to the path of the LOS and signal quality. The model may also be used to predict an obstruction state and/or a wireless signal quality score in a future time point. In some embodiments, the model is a machine learning model. Advanced modeling techniques such as artificial intelligence and machine learning methods can be used to facilitate the correlation and enhance the model. In other embodiments, multiple factors that contribute to the obstruction state may be involved in the machine learning model.

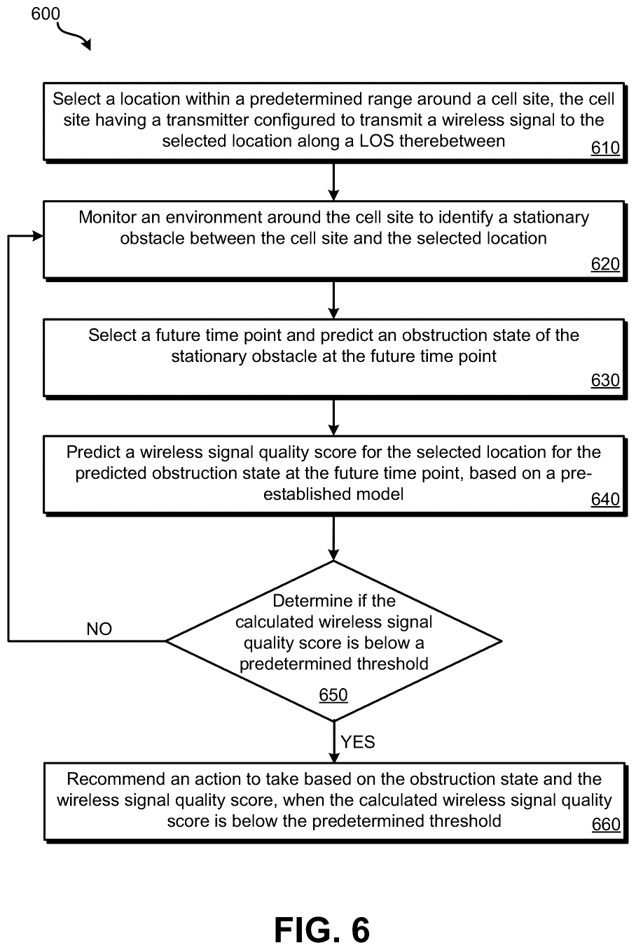

FIG. 6 is a flow chart diagram illustrating another example method 600 for predicting wireless signal performance of. At 610, a location within a predetermined range around a cell site is selected. The cell site has a transmitter configured to transmit a wireless signal to a wireless signal receiver placed in the selected location along a LOS between the transmitter and the receiver. At 620, an environment around the cell site is monitored (e.g., by one or more LIDAR sensors) to identify an obstacle between the cell site and the selected location.

At 630, a future time point is selected, and an obstruction state of the obstacle at the selected future is predicted, based on a pre-established model of obstruction. The model of obstruction may be established by operations of the method 500. In some embodiments, the model of obstruction may be a machine learning model trained with a plurality of obstruction states obtained at a plurality of time points.

At 640, a wireless signal quality score regarding a wireless transmission between the cell site and the selected location along the LOS is predicted, based on a pre-established model of signal quality. The model of signal quality may be a correlation model established by operations of the method 500. In some embodiments, the model of signal quality may be a machine learning model trained with a plurality of wireless signal quality scores obtained at each of a plurality of obstruction states at a plurality of time points. In some embodiments, a plurality of wireless signal quality subscores can be predicted, each of the plurality of wireless signal quality subscores corresponding to a frequency band or a selected frequency band.

At 650, a determination is made on if the calculated wireless signal quality score is below a predetermined threshold level. A wireless signal quality score below a predetermined threshold level is indicative of a transmission failure or an unacceptable obstruction to the path of the LOS. At 660, an action is recommended based on the predicted obstruction state and/or the predicted wireless signal quality score. The action may include remedial measures such as alteration of one or more operational parameters of the cell site, adjustment of transmitter antenna, mitigation/removal of the obstruction, wireless signal enhancement in the selected location, and so on. The remedial measures may mitigate the degree of obstruction, enhance the wireless signal quality, and improve the wireless transmission performance.

FIG. 7 is a schematic diagram illustrating an example of computer system 700. The computer system 700 is a simplified computer system that can be used to implement various embodiments described and illustrated herein. A computer system 700 as illustrated in FIG. 7 may be incorporated into devices such as a portable electronic device, mobile phone, or other device as described herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, a 602.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method, comprising:
selecting a location within a predetermined range around a cell site, the cell site having a transmitter configured to transmit a wireless signal to the selected location along a line of sight (LOS) therebetween;
scanning, using a light detection and ranging (LIDAR) sensor in proximity to the cell site, an environment around the cell site to identify an obstacle between the cell site and the selected location;
determining, based on the scanning, a degree of obstruction of the obstacle to a path of the LOS, the degree of obstruction being characterized by a ratio of an obstruction distance of the obstacle to a total distance of the LOS and the obstruction distance being characterized by a dimension of the obstructing part along the path of the LOS; and
responsive to determining that the degree of obstruction exceeds a threshold level, altering an operational parameter of the cell site.

2. The method of claim 1, further comprising:
measuring a distance between the obstacle and the cell site using the LIDAR sensor;
calculating a distance between the obstacle and the transmitter;
calculating the total distance of the LOS; and
determining the obstruction distance of the obstacle.

3. The method of claim 2, further comprising:
selecting a first time point (T₁) and determining a first obstruction state of the obstacle at T₁, the first obstruction state including a first degree of obstruction of the obstacle at T₁;
selecting a second time point (T₂) and determining a second obstruction state of the obstacle at T₂, the second obstruction state including a second degree of obstruction of the obstacle at T₂; and
comparing the first obstruction state and the second obstruction state to determine a change of the obstacle.

4. The method of claim 1, further comprising:
measuring a set of wireless signals received by a receiver placed in the selected location and transmitted from the transmitter to generate measurements data, the measurements data including a signal strength value and a signal to noise ratio (SNR);
calculating a signal quality score of the wireless signals based on the measurements data; and
determining whether the signal quality score falls within a predetermined range, the predetermined range indicating an acceptable performance of wireless transmission.

5. The method of claim 4, comprising:
obtaining a reference wireless signal quality score for the set of wireless signals;
selecting a first time point (T₁) and obtaining a first wireless signal quality score at T₁;
comparing the first wireless signal quality score with the reference wireless signal quality score; and
determining a signal quality loss corresponding to the obstacle at T₁, based on the comparison.

6. The method of claim 5, wherein obtaining the reference wireless signal quality score comprises:
measuring the set of wireless signals transmitted from the transmitter to a receiver placed in the selected location in absence of obstruction to the path of the LOS to obtain reference measurements data; and
calculating the reference wireless signal quality score of the set of wireless signals based on the reference measurements data.

7. The method of claim 4, further comprising:
determining one or more frequency bands of the set of wireless signals, the one or more frequency bands including at least one of: a low-band characterized by a frequency below 1 GHz, a mid-band characterized by a frequency from 1 GHz to 6 GHz, and a high band characterized by a frequency above 24 GHz.

8. The method of claim 7, further comprising:
determining one or more wireless signal quality subscores with respect to the one or more frequency bands.

9. A system for monitoring an environment around a cell site, the system comprising:
one or more processors; and
a computer-readable storage media storing computer-executable instructions that, when executed by the one or more processors, causes the system to:
select a location within a predetermined range around a cell site, the cell site having a transmitter configured to transmit a wireless signal to the selected location along a line of sight (LOS) therebetween;
receive cell site environment data and identify an obstacle between the cell site and the selected location based on the cell cite environment data, the cell site environment data obtained by scanning an environment around the cell site using a LIDAR sensor in proximity to the cell site;
determine, based on the cell site environment data, a degree of obstruction of the obstacle to a path of the LOS, the degree of obstruction being characterized by a ratio of an obstruction distance of the obstacle to a total distance of the LOS and the obstruction distance being characterized by a dimension of the obstructing part along the path of the LOS; and
responsive to determining that the degree of obstruction exceeds a threshold level, cause an alteration of one or more operational parameters of the cell site.

10. The system of claim 9, wherein, when executed by one or more processors, the computer-executable instructions further cause the system to:
obtain a distance between the obstacle and the cell site measured by the LIDAR sensor;
calculate a distance between the obstacle and the transmitter;
calculate the total distance of the LOS; and
determine the obstruction distance of the obstacle.

11. The system of claim 9, wherein, when executed by one or more processors, the computer-executable instructions further cause the system to:
select a first time point (T₁) and determining a first obstruction state of the obstacle at T₁, the first obstruction state including a first degree of obstruction of the obstacle at T₁;
select a second time point (T₂) and determining a second obstruction state of the obstacle at T₂, the second obstruction state including a second degree of obstruction of the obstacle at T₂; and
compare the first obstruction state and the second obstruction state to determine a change of the obstacle.

12. The system of claim 9, wherein, when executed by one or more processors, the computer-executable instructions further cause the system to:
receive measurements data corresponding to an obstruction state of the obstacle, the first measurements data obtained by measuring a set of wireless signals received by a receiver placed in the selected location and transmitted from the transmitter;
calculate a signal quality score of the wireless signals based on the measurements data; and
determine whether the signal quality score falls within a predetermined range, the predetermined range indicating an acceptable performance of wireless transmission.

13. The system of claim 12, wherein, when executed by one or more processors, the computer-executable instructions further cause the system to:
select a first time point (T₁) and calculate a first signal quality score of the wireless signals based on first measurements data, the first measurements data corresponding to a first obstruction state of the obstacle at T₁;
select a second time point (T₂) and calculate a second signal quality score of the wireless signals based on second measurements data, the second measurements data corresponding to a second obstruction state of the obstacle at T₂; and
compare the first and second signal quality scores to determine a change of signal quality.

14. The system of claim 12, wherein, when executed by one or more processors, the computer-executable instructions further cause the system to:
receive reference measurements data, the reference measurements data obtained by measuring the set of wireless signals transmitted from the transmitter to a receiver placed in the selected location in absence of obstruction to the path of the LOS; and
calculate a reference wireless signal quality score of the set of wireless signals based on the reference measurements data.

15. The system of claim 14, wherein, when executed by one or more processors, the computer-executable instructions further cause the system to:
compare the wireless signal quality score with the reference wireless signal quality score; and
determine a signal quality loss corresponding to the obstacle based on the comparison.

16. The system of claim 12, wherein, when executed by one or more processors, the computer-executable instructions further cause the system to:
determine one or more frequency bands of the set of wireless signals, the one or more frequency bands including at least one of: a low-band characterized by a frequency below 1 GHz, a mid-band characterized by a frequency from 1 GHz to 6 GHz, and a high band characterized by a frequency above 24 GHz.

17. A method, comprising:
selecting a location within a predetermined range around a cell site, the cell site having a transmitter configured to transmit a wireless signal to the selected location along a line of sight (LOS) therebetween;
scanning, using a light detection and ranging (LIDAR) sensor in proximity to the cell site, an environment around the cell site to identify an obstacle between the cell site and the selected location;
selecting a plurality of time points;
determining, based on the scanning, a plurality of degrees of obstruction of the obstacle respectively corresponding to the plurality of time points, the degree of obstruction being characterized by a ratio of an obstruction distance of the obstacle to a total distance of the LOS and the obstruction distance being characterized by a dimension of the obstructing part along the path of the LOS;
determining whether the degree of obstruction at one of the selected time points exceeds a threshold level; and
responsive to determining that the degree of obstruction exceeds a threshold level, altering an operational parameter of the cell site.

18. The method of claim 17, further comprising:
measuring a set of wireless signals transmitted from the transmitter to a receiver placed in the selected location at each of the plurality of time points to generate a plurality of measurements data respectively corresponding to the plurality of time points; and
calculating a plurality of signal quality scores of the wireless signals based on the plurality of measurements data, the plurality of signal quality scores respectively corresponding to the plurality of time points.

19. The method of claim 18, further comprising:
correlating the plurality of signal quality scores to the plurality of degrees of obstruction of the obstacle; and
generating a model for wireless transmission, based on the correlation.

20. The method of claim 19, further comprising:
selecting a future time point;
estimating a future wireless signal quality score at the further time point, based on the model for wireless transmission; and
determining whether the future signal quality score falls within the predetermined range.
